(19) United States
(12) Patent Application Publication
(10) Pub. No.: US 2021/0171859 A1
(43) Pub. Date: Jun. 10, 2021

(54) CONTINUOUS HEMP SEED OIL EXTRACTION SYSTEM AND METHODS

(71) Applicant: Marquette Analytica, Royal Oak, MI (US)

(72) Inventor: Robert Opperman, Midland, MI (US)

(21) Appl. No.: 17/068,092

(22) Filed: Oct. 12, 2020

Related U.S. Application Data
(60) Provisional application No. 62/914,983, filed on Oct. 14, 2019.

(51) Int. Cl. C11B 1/10; C11B 3/00; B01D 11/02; B01D 61/02; B01D 61/08; B01D 69/02

(52) U.S. Cl. CPC C11B 1/106; C11B 3/008; B01D 11/0265; B01D 11/0226; B01D 2325/34; B01D 61/027; B01D 61/08; B01D 69/02; B01D 11/0292

(57) ABSTRACT

The disclosure relates to a Cannabis seed processing method and system comprising ultrasonic treatment of Cannabis seeds coupled to a membrane extraction system for efficient recovery of hemp seed oil.

### CROSS REFERENCE TO RELATED PATENT APPLICATIONS

This patent application claims priority to U.S. Provisional patent Application No. 62/914,983, filed Oct. 14, 2019, the disclosure of which is herein incorporated by reference in its entirety.

### BACKGROUND

Cannabis has been used as a source of fiber to make paper and clothing, as a recreational drug, and in traditional medicine. Historically, Cannabis has been divided into three species: Cannabis sativa, Cannabis indica, and Cannabis ruderalis. These species have been extensively hybridized, and the resulting hybrids are classified as C. sativa and can be further characterized by chemotype according to the cannabinoid profile. Cannabis plants having high THC levels are often used for medicinal properties. In contrast, Cannabis plants having low THC levels (hemp) have been used in textiles and foods. The lift of the ban on industrial hemp (defined as cannabis having a THC content of less than 0.3% by weight) in the United States and Europe has made industrial hemp an attractive source of fiber, hemp seed, hemp seed oil, and cannabinoids. The current methodology used for the extraction of hemp seed oil from hemp seeds involves high energy costs. There exists a need for more efficient methods of rapid preparation of purified hemp seed oil from hemp seeds with high yields and purity, substantially free from contaminants.

### SUMMARY

The disclosure provides, among other things,

A method for extracting Cannabis seed oil comprising: applying ultrasonic cavitation with an ultrasonic cavitation device to a mixture comprising Cannabis seed material and at least one solvent in an extraction tank, to produce a crude hemp seed oil stream; the extraction tank having a first end proximal to the ultrasonic cavitation device and a second end distal to the ultrasonic cavitation device; the extraction tank comprising a screw conveyor located inside the extraction tank, the screw conveyor capable of moving the Cannabis seed material from the first end to the second end; and filtering the crude hemp seed oil stream through at least one membrane to produce a refined hemp seed oil.

In an embodiment, the method further comprises moving the Cannabis seed material to an output port located at the second end.

In an embodiment, the screw conveyor is a varied geometry screw conveyor. The screw conveyor may have a central axis, the central axis making an incline angle θ of about 1° to about 45° C. relative to a horizontal plane intersecting the central axis. The incline angle may be between 1° and 15°. The incline angle may be between 3° and 15°.

In an embodiment, the sonication device is horn, probe, cup, or rod shaped.

In an embodiment, the sonication device may produce an ultrasound frequency between 10 kHz to 100 kHz. The ultrasound frequency may be about 11, 12, 13, 14, 15, 16, 17, 18, 19, 20, 25, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, or 100 kHz. The ultrasound frequency may be about 20-50 kHz, 10-100 kHz, 15-40 kHz, 18-40 kHz, 21-45 kHz, 26-38 kHz, 29-39 kHz, 32-35 kHz, 320-38 kHz, 310-40 kHz, 20-40 kHz, 10-40 kHz, 30-40 kHz, 25-50 kHz, 25-35 kHz, or 29-39 kHz. The ultrasound frequency may be about 35 kHz.

In an embodiment, the ultrasonic device may be situated above the proximal end of screw conveyor. The ultrasonic device may be situated below the proximal end of screw conveyor.

The extraction tank may have a drain configured to collect the crude hemp seed oil stream. The drain may be below the ultrasonic device and above the proximal end of the screw conveyor. The drain may be below the ultrasonic device and below the proximal end of the screw conveyor.

In an embodiment, the ultrasonic cavitation does not substantially disrupt the Cannabis seed material.

In an embodiment, the ultrasonic cavitation is applied at a power of 500 to 1,000 kW/kg of Cannabis seed material and at least one solvent by weight. The power may be 500, 550, 600, 650, 700, 750, 800, 850, 900, 950, or 1,000 kW/kg of Cannabis plant material and at least one solvent by weight. The power may be 100 to 900 kW/kg Cannabis plant material and at least one solvent by weight, 5 to 1,000 kW/kg of Cannabis plant material and at least one solvent by weight, 500 to 750 kW/kg of Cannabis plant material and at least one solvent by weight, 500 to 600 kW/kg of Cannabis plant material and at least one solvent by weight, 650 to 800 kW/kg of Cannabis plant material and at least one solvent by weight, or 750 to 950 kW/kg of Cannabis plant material and at least one solvent by weight.

In an embodiment, the mixture comprising Cannabis seed material and at least one solvent has a temperature between 25° C. and 68° C. The temperature may be about 25° C., 26° C., 27° C., 28° C., 29° C., 30° C., 31° C., 35° C., 37° C., 39° C., 40° C., 41° C., 42° C., 43° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., or 68° C. The temperature may be between about 25° C. to 60° C., 40° C. to 50° C., 25° C. to 30° C., or 25° C. to 55° C.

In an embodiment, the solvent is an organic solvent, water, or a combination thereof. The organic solvent may be an alcohol, ether, ester, ketone, alkane, and combinations thereof. The alkane may be pentane, hexane, heptane, or a combination thereof. The alkane may be hexane.

In an embodiment, the ultrasonic cavitation is applied for between 30 seconds and 5 minutes. The ultrasonic cavitation may be applied for about 1, 2, 3, 4, or 5 minutes. The ultrasonic cavitation may be applied for 30-180 seconds, 60-120 seconds, 60-180 seconds, 30-150 seconds, 60-125 seconds, 50-145 seconds, 40-135 seconds, 120-145 seconds, 120-180 seconds, 120-150 seconds, 127-135 seconds, 60-140 seconds, 80-150 seconds, 90-320 seconds, 100-125 seconds, or 59-121 seconds. The ultrasonic cavitation may be applied for about 1 minute. The ultrasonic cavitation may be applied for about 2 minutes.

In an embodiment, the ultrasonic cavitation is applied in pulses. The ultrasonic cavitation may be applied for 5 seconds, then off for 5 seconds, and repeated for a total of 30 to 180 seconds. The ultrasonic cavitation may be applied for 5 seconds on/5 seconds off, 10 seconds on/10 seconds off, 15 seconds on/15 seconds off, 20 seconds on/20 seconds off, 25 seconds on/25 seconds off, 30 seconds on/30 seconds off, 35 seconds on/35 seconds off, 40 seconds on/40 seconds off, 45 seconds on/45 seconds off, or 50 seconds on/50 seconds off. The ultrasonic cavitation may be applied for 5 seconds on/10 seconds off, 10 seconds on/20 seconds off, 25 seconds on/15 seconds off, 20 seconds on/40 seconds off, 35 seconds on/25 seconds off, 35 seconds on/30 seconds off, 135 seconds on/35 seconds off, 120 seconds on/30 seconds off, 60 seconds on/120 seconds off, or 100 seconds on/50 seconds off.

In an embodiment, the membrane filtration comprises a membrane filter producing a retentate and a permeate.

In an embodiment, the membrane has a molecular weight cutoff of about 150 Daltons. The membrane molecular weight cutoff may be about 50, 75, 100, 125, 150, 175, 200, 225, 250, 275, 300, 325, 350, 375, 400, 425, 450, 475, or 500 Daltons.

In an embodiment, the retentate comprises refined hemp seed oil.

The retentate may be substantially free of terpenes, pesticides, fungicides, cannabinoids, solvents, plant material, organelles, nucleic acids, lignin, hemicellulose, cellulose, fertilizers, and mixtures thereof. The retentate may comprise a concentration of terpenes, pesticides, fungicides, cannabinoids, solvents, fertilizers, and mixtures ranging from about 0 ppm to 10 ppm. The retentate may comprises less than 0.5%, 0.1%, 0.01%, or 0.001% w/w pesticides, fungicides, fertilizers, plant material, solvent, organelles, nucleic acids, lignin, and mixtures thereof.

In one embodiment, the permeate comprises the solvent. The solvent may be collected, stored, and/or reused in the method.

In one embodiment, the volumetric flow rate of the permeate through the membrane is from about 0 L/h to about 1000 L/h, from about 10 L/h to about 750 L/h, from about 20 L/h to about 500 L/h, from about 30 L/h to about 450 L/h, from about 40 L/h to about 400 L/h, from about 50 L/h to about 350 L/h, from about 75 L/h to about 300 L/h, from about 100 L/h to about 250 L/h.

In one embodiment, the volumetric flow rate of the solvent through the membrane is from about 0 L/h to about 10 L/h, from about 10 L/h to about 50 L/h, from about 50 L/h to about 100 L/h, from about 100 L/h to about 200 L/h, from about 200 L/h to about 400 L/h, from about 400 L/h to about 600 L/h, from about 600 L/h to about 800 L/h, from about 800 L/h to about 1000 L/h.

In one embodiment, the pressure at the membrane ranges from about 50 psi to about 100 psi, from about 100 psi to about 150 psi, from about 150 psi to about 200 psi, from about 200 psi to about 250 psi, from about 250 psi to about 300 psi, from about 300 psi to about 350 psi, from about 350 psi to about 400 psi, from about 400 psi to about 450 psi, from about 450 psi to about 500 psi, from about 500 psi to about 550 psi, or from about 550 psi to about 600 psi.

In an embodiment, the concentration of the cannabinoids in the crude hemp seed oil stream is between about 0% (w/w) and about 0.1% (w/w), inclusive.

In an embodiment, the cannabis seed material is from hemp having less than 0.3% (w/w) THC.

In an embodiment, the cannabis seed material is washed, dried, hulled, comminuted, or a combination thereof. The cannabis seed material may be hulled (e.g., the husk and shell is removed). The cannabis seed material may be hulled mechanically.

In an embodiment, the cannabis seed material is ejected at the opposite terminus from the input into the screw conveyor, optionally by means of screw conveyor.

In an embodiment, the membrane is an organic solvent stable membrane. The membrane may be a silicone membrane. In an embodiment, the membrane is a rifluoropropylmethylsiloxane dimethylsiloxane (PDMS-PTFPMS)/polyvinylidene fluoride (PVDF) membrane.

In an embodiment, the solvent to biomass ratio may be about 1:1, 1.5:1, 2:1, 3:1, 3.5:1, 3.75:1, 4:1, 4.5:1, 5:1, 5.5:1, 6:1, 6.25:1, 6.5:1, 6.75:1, or 7:1.

In an embodiment, the cannabis seed material may be collected after sonication.

In an embodiment, the method may be a continuous method.

In an embodiment, the method may be a batch method.

In an embodiment, the method may further comprise admixing Cannabis seed material with at least one solvent, to form a mixture, for 1-20 minutes prior to adding the mixture to the extraction tank and prior to the applying ultrasonic cavitation.

In an embodiment, the method may further comprise admixing Cannabis seed material with at least one solvent, to form a mixture, for 1, 2, 3, 4, 5, 6, 7, 8, 9, 10, 11, 12, 13, 14, 15, 16, 17, 18, 19, or 20 minutes prior to adding the mixture to the extraction tank and prior to the applying ultrasonic cavitation.

In an embodiment, the method may further comprise admixing Cannabis seed material with at least one solvent, to form a mixture, for 2-16, 1-18, 4-16, 3-14, 4-15, 5-13, 5-12, or 1-16 minutes prior to adding the mixture to the extraction tank and prior to the applying ultrasonic cavitation.

In an embodiment, the crude hemp seed oil stream collected may comprise about 0.001% to 1% cannabinoids by weight (w/w).

A system for extracting Cannabis seed oil comprising: an extraction tank having a first end proximal to an ultrasonic cavitation device and a second end distal to the ultrasonic cavitation device; the extraction tank comprising a screw conveyor located inside the extraction tank, the screw conveyor capable of moving material from the first end to the second end; and in fluid communication with at least one membrane filtration system.

In an embodiment, the screw conveyor is a varied geometry screw conveyor. The screw conveyor may have a central axis, the central axis making an incline angle θ of about 1° to about 45° C. relative to a horizontal plane intersecting the central axis. The incline angle may be between 1° and 15°. The incline angle may be between 3° and 15°.

In an embodiment, the sonication device is horn, probe, cup, or rod shaped. The ultrasonic device may be situated above the proximal end of screw conveyor. The ultrasonic device may be situated below the proximal end of screw conveyor.

In an embodiment, the extraction tank has a drain configured to collect a crude hemp seed oil stream. The drain may be below the ultrasonic device and above the proximal end of the screw conveyor. The drain may be below the ultrasonic device and below the proximal end of the screw conveyor.

The screw conveyor may be food-grade material. The food-grade material may be stainless steel, PTFE (Teflon), or food grade plastic, optionally high-density polyethylene (HDPE).

In an embodiment, the membrane may be an organic solvent stable membrane. The membrane may be a silicone membrane. The membrane may be a rifluoropropylmethylsiloxane dimethylsiloxane (PDMS-PTFPMS)/polyvinylidene fluoride (PVDF) membrane. The membrane may have a molecular weight cutoff of about 150 Daltons. The membrane may have a molecular weight cutoff of about 50, 75, 100, 125, 150, 175, 200, 225, 250, 275, 300, 325, 350, 375, 400, 425, 450, 475, or 500 Daltons.

### BRIEF DESCRIPTION OF THE DRAWINGS

FIG. 1A-B is a schematic of an embodiment of an ultrasonic cavitation system for extracting hemp seed oil from cannabis seeds according to the disclosure.

FIG. 2 is a flow-chart of the method steps for membrane filtration of a crude hemp seed oil stream to collect refined hemp seed oil according to the disclosure.

FIG. 3 is a flow-chart of the method steps for membrane filtration of a crude hemp seed oil stream to collect refined hemp seed oil according to the disclosure.

FIG. 4 is a flow-chart of the method steps for membrane filtration of a crude hemp seed oil stream to collect refined hemp seed oil according to the disclosure.

### DETAILED DESCRIPTION

### Hemp Seeds and Hemp Seed Oil

Cannabis is an annual, dioecious, flowering herb native to Asia. The leaves are palmately compound or digitate, with serrate leaflets. The first pair of leaves usually have a single leaflet, the number gradually increasing up to a maximum of about thirteen leaflets per leaf (usually seven or nine), depending on variety and growing conditions. At the top of a flowering plant, this number falls to a single leaflet per leaf. The lower leaf pairs usually occur in an opposite leaf arrangement and the upper leaf pairs in an alternate arrangement on the main stem of a mature plant. A single cannabis plant may produce over 2,000 seeds.

Hemp seeds are classified as a nut or achene. They have an outer sheath, a hard shell and an inner kernel. Before the seeds are pressed, they may be cleaned, removing residual plant matter. The hulled (seeds where the outer shell has been removed) are referred to as “hemp hearts.” Hemp seeds are edible and contain about 35% oil and 25% protein. Hemp seed oil can be used to make paints, varnishes, soaps, and edible oil with a low smoke point. The Soviet Union made a butter substitute from hemp seed oil known as “Soviet Butter.” Historically, the chief commercial use of hemp seed has been for bird feed.

Hemp seeds contain omega-3 fatty acids, omega-6, and omega-9 fatty acids. Hemp seed oil usually comprises linoleic acid (LA; C18:2, an omega-6 fatty acid), α-linolenic acid (ALA; C18:3, an omega-3 fatty acid), GLA (C18:3; omega-6), stearidonic acid (SDA; C18:4; omega-3), oleic acid (C18:1), palmitic acid (C16:0), stearic acid (C18:0), and eicosenoic acid (EA; C20:1). Hemp seeds also contain all twenty naturally occurring amino acids. Hemp seeds do not contain a significant amount (or even a detectable amount) of tetrahydrocannabinol (THC). Arno Hazekamp et al. Chapter 3 in Comprehensive Natural Products II, 2010; Leizer et al. (2000) Journal of Nutraceuticals, Functional & Medical Foods. 2(4).

### Hemp Seed Oil Extraction

The disclosure generally relates to improved methods for hemp seed oil extraction, both crude hemp seed oil and refined hemp seed oil. For example, the disclosure relates to a method for processing Cannabis seed material comprising: applying ultrasonic cavitation with an ultrasonic cavitation device to a mixture comprising Cannabis seed material and at least one solvent in an extraction tank, to produce a crude hemp seed oil stream; the extraction tank having a first end proximal to the ultrasonic cavitation device and a second end distal to the ultrasonic cavitation device; the extraction tank comprising a screw conveyor located inside the extraction tank, the screw conveyor capable of moving the Cannabis seed material from the first end to the second end; and filtering the crude hemp seed oil stream through at least one membrane to produce a refined hemp seed oil. The refined hemp seed oil may be collected, tested, weighed, and packaged, preferably in nitrogen-flushed, light proof containers (e.g., vials, bottles, or drums).

In another example, the disclosure relates to a method for processing cannabis seed material comprising: supplying cannabis seed material to a screw conveyor arranged in a chamber comprising a sonication device configured to provide ultrasonic cavitation and admixing with a solvent at a temperature between 25° C. and 68° C.; applying ultrasonic cavitation at a sufficient power to disrupt the hemp seed material and produce a crude hemp seed oil stream; collecting the crude hemp seed oil stream; moving the cannabis plant material along the screw conveyor away from the sonication probe towards an output port; and subjecting the crude hemp seed oil stream to membrane filtration to produce a refined hemp seed oil.

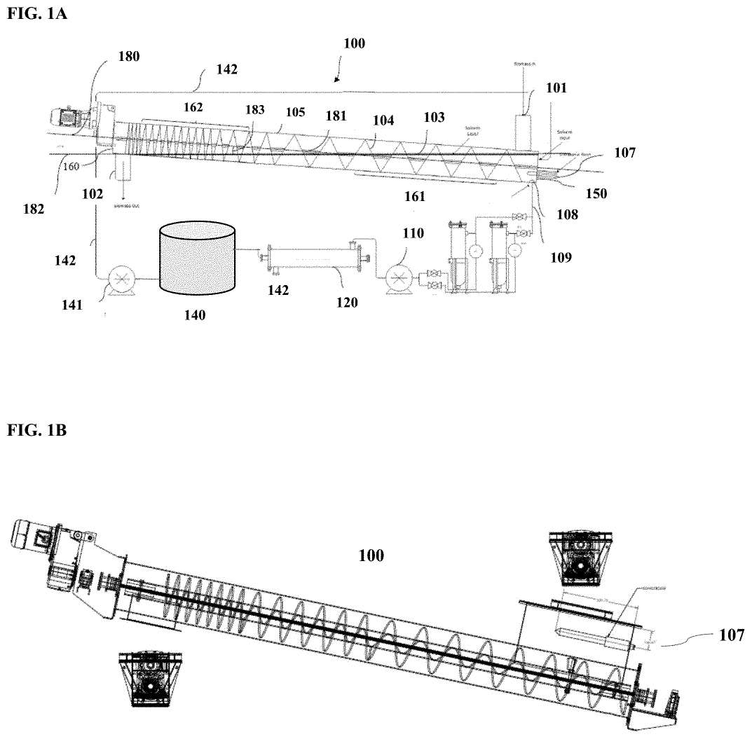

Making reference to FIG. 1A, a screw conveyor extraction system 100 comprising an extraction tank 105 configured with a varied geometry screw conveyor 104, in this example is inclined, is coupled to a biomass input 101 at the proximal end 150 and a biomass output 102 at the distal end 160. Although FIG. 1A shows a single screw conveyor extraction system 100, the methods described herein also contemplate a plurality (e.g., two, three, four, or more) of screw conveyor extraction systems 100 arranged in parallel.

The extraction tank 105 has a central axis 180 going through the varied geometry screw conveyor's 104 spindle 181. The incline of the extraction tank 105 can be varied such that the central axis 180 makes an incline angle θ 183 of about 1° to about 45° C. (e.g., about 3° to about) 15° relative to a horizontal plane 182 intersecting the central axis 180. Varied geometry screw conveyor 104 is coupled to a sonication device 107 situated in close proximity (e.g., about 1 to about 10 cm) from a drain 108. A solvent level 103 is highest at the proximal end 150 with the sonication device 107 and drain 108 and lowest at the distal end 160 with the biomass output 102. The sonication device 107 is situated above the drain 108 which is above the proximal end 150 of the varied geometry screw conveyor 104, preferably above the shaft of the proximal end 150 of the varied geometry screw conveyor 104. The varied geometry screw conveyor 104 has steadily decreasing pitch between the blades as to configured to compress the biomass as it passes from the biomass input at the proximal end 150 to the biomass output 102 at the distal end 160. The drain 108 is fluidly coupled to a crude hemp seed oil stream output 109, which is, in turn, fluidly coupled to a membrane pump 110 that pressurizes the crude hemp seed oil stream and sends it through a membrane system 120. The membrane 120 is a desolvent membrane that removes solvent from the crude hemp seed oil stream to give a retentate and a permeate. The permeate 142 comprising the solvent is collected. The permeate can be collected in a solvent reserve tank 140 that can comprise a thermostat control. Solvent reserve tank 140 is fluidly coupled to the membrane filtration system, and specifically to desolvent membrane 120, via conduit. Solvent reserve tank collects permeate from desovlent membrane 120, stores it, adjusts the aqueous solution temperature as necessary, and is coupled to a solvent return pump 141 coupled to a solvent return line 142 configured to send the recovered solvent into the extraction tank 105. The retentate comprises the refined hemp seed oil 142 which is collected for further processing.

In sum, the system and methods described herein provide an extraction platform employing various solvents (e.g., organic solvents) where a pretreated cannabis biomass input (e.g., hulled) is fed into an extraction system (e.g., extraction system 100) comprising an inclined screw conveyor 104 into which a suitable solvent is provided to a suitable solvent level 103. The biomass can be pretreated by admixing with a solvent prior to being fed into the extraction system. For example, the biomass can be pretreated with solvent for any suitable amount of time, such as for about 1 minute to about 20 minutes, prior to being fed into the extraction system or while being fed into the extraction system via a screw conveyor. The biomass is fed into extraction system 100 via biomass input 101 at the proximal end 150 of extraction system 100. Screw conveyor 104 moves the biomass through the solvent at an extraction rate based on the scale of the biomass input rate as a function of temperature and solvent-biomass contact time. In addition, sonication device 107 capable of various output frequencies is placed near the biomass input 101 to facilitate an expedient extraction and stimulate a biomass particle void in the solution near drain 108.

Screw conveyor 104 has a progressive decrease in screw pitch with respect to the input (widest screw pitch, e.g., in zone one 161) to the output (progressively shorter screw pitch, e.g., in zone two 162), e.g., varied geometry screw conveyor. The change in screw pitch compresses the biomass thereby extracting solvent comprising desired compounds, the solvent flowing toward proximal end 150.

At distal end 160 compressed biomass material is ejected through biomass output 102 into either a basin (not shown) or an additional conveyor system (not shown) to remove spent biomass material from screw conveyor extraction system 100. The spent biomass could be collected for further processing, composted, or discarded.

Drain 108 is located at proximal end 150 of screw conveyor 104 with an ultrasonic sonication device 107 in proximity to the drain 108 in order to stimulate a particle “void” in solution. This “void” is created in order to prevent biomass particle buildup near the drain port and minimize filtration of the crude hemp seed oil extract post-extraction. In one embodiment, the sonication device 107 and the drain 108 are placed above the proximal end 150 of screw conveyor 104. In one embodiment, the sonication device 107 and the drain 108 are placed below the proximal end 150 of screw conveyor 104. In addition, while not wishing to be bound by any specific theory, it is believed that the use of a solvent in conjunction with ultrasonic power and frequency settings of the sonication device 107 disrupts the hemp seed and liberates the hemp seed oil without substantially disrupting cannabis seed material. This has an unexpected advantage of only releasing the hemp seed oil and leaving most of the cannabis seed material intact. This avoids the problem of fibers, lignin, organelles, and other plant parts from entering the downstream processing steps (e.g., at the membrane system 120).

The crude hemp seed oil stream is pumped through a membrane filter to remove residual solvent. The filtered crude hemp seed oil discharge is pumped through a suitable semi-permeable membrane in membrane system 120. The membrane 120 is a desolvent membrane that removes solvent from the crude hemp seed oil stream to give a retentate and a permeate. The membrane 120 is selected by pore size to remove any materials larger than the selected membrane pore such the fatty acids. The solvent will permeate this stage, leaving behind a retentate, which comprises the refined hemp seed oil. The retentate, comprising the refined hemp seed oil, can be sent for further post-processing and the permeate, comprising the solvent (e.g., hexane) can be thermostatically prepared (e.g., at solvent reserve tank) at the selected extraction temperature and returned to extraction tank 105 in proximity to biomass input 101.

### Cannabis Plant Material

The starting material that is provided to biomass input 101 for the methods and systems described herein can be any cannabis seed material, including but not limited to raw cannabis seed material, pretreated cannabis plant material, parts of any cannabis seeds, hemp hearts (cannabis seeds with the hulls removed), or combinations thereof. The starting material may also be hemp (industrial hemp) seeds, whether whole or hulled (having their shells removed).

### Processing of Cannabis Plant Material

For pretreatment, the Cannabis plant material can be washed, dried, and/or hulled. The cannabis plant material can be added to the screw conveyor extraction system 100 after being hulled and mixed with a solvent for a suitable amount of time (e.g., 1-20 minutes) at any suitable temperature (e.g., 25° C. to 68° C.). The Cannabis plant material, whether pretreated or not, can be mixed directly with any suitable solvent (e.g., hexane) at any suitable ratio by weight of solvent to biomass to extract cannabinoids, lipids, and terpenes from the biomass. For example, the Cannabis seed material can be admixed with an organic solvent at a 4:1, 4.5:1, 5:1, 5.5:1, 6:1, 6.25:1, 6.5:1, 6.75:1, 6.8:1, 6.9:1, or 7:1, solvent to biomass ratio by weight for about 1 minute to about 20 minutes at 25° C. to 70° C. The Cannabis seed material can then be introduced into screw conveyor extraction system 100 by means of a screw conveyor and subjected to ultrasonic cavitation. The ultrasonic cavitation can serve to, among other things, disrupt the hemp seed. It has been surprisingly discovered that directly applying ultrasonic cavitation to the Cannabis seed material in an organic solvent can release almost 100% of the hemp seed oil contained therein in 2 minutes or less. This is in contrast to current methods that require hours and release less than 50% of the hemp seed oil, as well as other components.

Although the examples described herein use a screw conveyor extraction system 100, other systems can be used. Regardless of the system used, the Cannabis seed material can be admixed with a suitable solvent (e.g., hexane), subjected to ultrasonic cavitation, and maintained at a temperature between 25° C. and 68° C. or higher, where appropriate. The ultrasonic cavitation can serve to, among other things, disrupt the hemp seed structure. This releases the hemp seed oil into the solvent. The plant material, comprising cellulose, hemicellulose, and lignin, is moved away from the proximal end of the screw conveyor processor by means of the screw conveyor. In the example provided in FIG. 1A-B, varied geometry screw conveyor moves the processed Cannabis seed material away from the ultrasonic cavitation device (e.g., sonication device 107), and progressively applies pressure by means of tighter screw spacing, until, at the distal end, the processed Cannabis seed material is expelled from the screw conveyor processor. The process cannabis material can be dried to remove the residual solvent, recovered for further processing, or discarded.

Suitable solvents that can be used to extract cannabinoids from the Cannabis plant material include organic solvents, water (e.g., potable water), and combinations thereof. Organic solvents include alcohols, ethers, esters, ketones, alkanes, and combinations thereof. Examples of alcohols include methanol, ethanol, n-propanol, 1-propanol, n-butanol, sec-butanol, t-butanol, 1-pentanol, amyl alcohol, isoamyl alcohol, 1-hexanol, 2-hexanol, 3-hexanol, 1-heptanol, 2-heptanol, 3-heptanol, 4-heptanol, 1-octanol, 2-octanol, 1-nonanol, 1-decanol, or a mixture thereof. For example, the alcohol can be methanol, ethanol, or a mixture thereof. The solvent can be ethanol (e.g., as the sole solvent). The solvent can be methanol (e.g., as the sole solvent). The solvent can also comprise water. Examples of ethers include diethyl ether, dipropyl ether, tetrahydrofuran, and the like and combinations thereof. Examples of esters include ethyl acetate and the like. Examples of ketones include acetone, methyl ethyl ketone, and the like and combinations thereof. Examples of alkanes include pentane, hexane, heptane, and the like and combinations thereof. Suitable solvents can be substantially free of detergents, emulsifiers, solubilizers, organic solvents, or any combination thereof.

### Ultrasonic Cavitation

A processing unit (e.g., extraction system 100) comprising an ultrasonic cavitation device (e.g., sonication device 107), a screw conveyor 104, biomass input port, biomass output port, and drain. The processing unit can be a solvent-containing tank that has at least one ultrasonic cavitation device comprising an ultrasonic transducer. The ultrasonic transducer can be of any suitable shape and dimension. For example, the ultrasonic probe can have any suitable shape (e.g., horn, probe, cup, or rod shaped) and can be immersed in a liquid or attached to the inside of the processing unit. Although conventional transducers are mounted to the outside of the tank, the ultrasonic transducer described herein can be disposed internal to the tank and suspended in the solvent column by one or more support brackets. Generally, the submerged transducers are more efficient, and the external transducer tend to damage the ultrasonic tank over time. The transducer can be a rod made of titanium or other metal, or metal alloy. The transducer can have a length of one to four feet long and can be rod shaped or any other suitable shape (e.g., horn, probe or cup shaped). The ultrasonic probe may be place above the drain which is above the proximal end of the screw conveyor. As the biomass is fed into the system, it is subjected to ultrasonic cavitation that releases the hemp seed oil, leaving the biomass mostly intact. This avoids the problem of disrupting the lignocellulosic biomass, releasing nucleic acids, or bursting plant cells.

The ultrasonic energy created by the transducer produces sufficient intensity of ultrasonic energy to disrupt the hemp seed structure, releasing the oils into a crude hemp seed oil stream. An electrical signal from a generator feeds into the transducers, creating sound in the fluid strong enough to create cavitation of the solution and disrupt the hemp seed structure. The electrical signal can come from a generator located external to the tank, and it can be connected to the transducers located within the tank by a lead. In contrast with current methods that focus on disrupting the plant material, which leads to the release of fibers, lignin, organelles, nucleic acids that tend to foul membranes, a synergistic combination of ultrasonic power and frequency in a solvent at a short time interval releases the hemp seed oil, while leaving the cannabis plant material substantially intact, has been discovered.

### Temperature

The solution and/or the mixture (e.g., a mixture comprising Cannabis seed material and at least one solvent) inside the processing unit (e.g., extraction system 100) comprising the Cannabis seed material can undergo ultrasonic cavitation at any suitable temperature. The temperature can be between about 25° C. to about 68° C. For example, when the solvent used in the processing unit is hexane, the temperature can be below the boiling point of hexane (e.g., about 68° C.). In other examples, the temperature of the solution and/or the mixture inside the processing unit can be about 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., or about 68° C. In other examples, the temperature of the solution and/or the mixture inside the processing unit can be between about 20° C. to 60° C., 30° C. to 50° C., 25° C. to 40° C., or 25° C. to 35° C.

### Time

The Cannabis seed material/solvent mixture may undergo ultrasonic cavitation, where ultrasonic cavitation is applied for any suitable amount of time, such as from about 30 seconds to about 180 seconds, about 20 to about 40 seconds or the cannabis plant material can be undergo ultrasonic treatment, where ultrasonic cavitation is applied for about 30 seconds. The cannabis plant material can undergo ultrasonic treatment, where ultrasonic cavitation is applied for about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 seconds. The cannabis plant material can be exposed to ultrasonic energy, where ultrasonic cavitation is applied for 30-180 seconds, 60-180 seconds, 50-150 seconds, 65-135 seconds, 120-180 seconds, 125-140 seconds, 60-140 seconds, 55-95 seconds, 59-109 seconds, 58-131 seconds, 63-132 seconds, 49-138 seconds, or 34-157 seconds.

The ultrasonic cavitation may be pulsed, i.e., applied via a mixture of on and off cycles. For example, the ultrasonic cavitation may be applied for 5 seconds, then off for 5 seconds, and repeated for a total of 30 to 180 seconds. The ultrasonic cavitation pulsing may be on “on/off” cycle. The ultrasonic cavitation may be an equal set of “on/off” pulses, for example, 5 seconds on/5 seconds off, 10 seconds on/10 seconds off, 15 seconds on/15 seconds off, 20 seconds on/20 seconds off, 25 seconds on/25 seconds off, 30 seconds on/30 seconds off, 35 seconds on/35 seconds off, 40 seconds on/40 seconds off, 45 seconds on/45 seconds off, or 50 seconds on/50 seconds off. In another embodiment, the ultrasonic cavitation may be an unequal set of “on/off” pulses, for example, 5 seconds on/10 seconds off, 10 seconds on/20 seconds off, 25 seconds on/15 seconds off, 20 seconds on/40 seconds off, 35 seconds on/25 seconds off, 35 seconds on/30 seconds off, 135 seconds on/35 seconds off, 120 seconds on/30 seconds off, 60 seconds on/120 seconds off, or 100 seconds on/50 seconds off.

### Soak in Solvent

The cannabis seed material, whether hulled hemp hearts or whole hemp seeds, may be soaked in a solvent (e.g., hexane) prior to ultrasonic cavitation for about 1-30 minutes. The cannabis seed material may be soaked in solvent for about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes prior to ultrasonic cavitation. The cannabis seed material may be soaked in solvent for about 1-5, 6-10, 11-15, 16-20, 20-25, or 25-30 minutes prior to ultrasonic cavitation. The cannabis seed material may be subjected to agitation (mixing) during the soak time.

### Power

Any high-power ultrasonic device can be used in the methods and systems described herein. Power requirements are a function of the amount of biomass:solvent mixture being subjected to ultrasonic cavitation. The power range can be expressed in terms of kilowatts of ultrasonic energy per kilogram of biomass and solvent, for example the ultrasonic cavitation can be applied at a power of from about 500 to about 1,000 kW/kg of biomass and solvent by weight (e.g., Cannabis seed material and at least one solvent by weight), which is an amount of power sufficient to disrupt the cannabis seeds. For example, the ultrasonic cavitation can be applied at a power of about 500, 550, 600, 650, 700, 750, 800, 850, 900, 950, or 1,000 kW/kg of biomass and solvent by weight. The ultrasonic cavitation can be applied at a power of about 500 to about 900 kW/kg of biomass and solvent by weight, about 600 to about 1,000 kW/kg of biomass and solvent by weight, about 750 to about 900 kW/kg of biomass and solvent by weight, about 600 to about 800 kW/kg of biomass and solvent by weight, about 700 to about 800 kW/kg of biomass and solvent by weight, or about 850 to about 950 kW/kg of biomass and solvent by weight.

### Frequency

The ultrasonic unit can use ultrasonic energy at about 10 to about 100 kHz. For example, the ultrasonic system can use a frequency of about 35 kHz. The generator should produce enough power to generate a transducer frequency about 10 to about 100 kHz. For example, the ultrasonic disruption can be performed at a frequency of about 10 kHz, 20 kHz, 21 kHz, 22 kHz, 23 kHz, 24 kHz, 25 kHz, 26 kHz, 27 kHz, 28 kHz, 29 kHz, 30 kHz, 31 kHz, 32 kHz, 33 kHz, 34 kHz, 35 kHz, 36 kHz, 37 kHz, 38 kHz, 39 kHz, 40 kHz, 41 kHz, 42 kHz, 43 kHz, 44 kHz, 45 kHz, 46 kHz, 47 kHz, 48 kHz, 49 kHz, 50 kHz, 55 kHz, 60 kHz, 65 kHz, 70 kHz, 75 kHz, 80 kHz, 85 kHz, 90 kHz, 95 kHz, or about 100 kHz. The ultrasonic disruption can be at a frequency of about 20 to about 50 kHz, about 10 to about 100 kHz, about 30 to about 70 kHz, about 280 to about 40 kHz, about 21 to about 450 kHz, about 26 to about 380 kHz, about 29 to about 39 kHz, about 32 to about 36 kHz, about 34 to about 38 kHz, about 25 to about 40 kHz, about 30 to about 40 kHz, about 10 to about 40 kHz, about 30 to about 45 kHz, about 25 to about 50 kHz, about 31 to about 39 kHz, or about 32 to about 42 kHz. The ultrasonic treatment can be at a frequency of about 35 kHz. The ultrasonic treatment can be performed at a frequency of about 35 kHz, at about 100 Watts of power, for about 120 seconds.

### Membrane Filtration System

After the Cannabis seed material has been subjected to ultrasonic cavitation in a solvent as described herein, one obtains a crude hemp seed oil stream comprising a solvent comprising a mixture of solvent and hemp seed oil. The crude hemp seed oil stream is collected by means of the drain 108 and pumped through a membrane system 120. The membrane 120 is a desolvent membrane that removes solvents from the crude hemp seed oil stream to give a retentate and a permeate.

Membrane Filter

The crude hemp seed oil stream is filtered through a membrane to produce a permeate and a retentate. Suitable membranes have a molecular weight cutoff of about 150 Da and are made of silicone. The retentate may comprise the refined hemp seed oil. The permeate comprises the solvent.

Suitable membranes for use in the disclosed methods include DuraMem membranes produced by Evonik (Essen, Germany). Other organic solvent stable filters, include but are not limited to SolSep UF10706, SolSep UF03705, and SolSep NF080105 produced by SolSep BV (St. Eustatius, Netherlands); and Novamem PVDF20 and Novamem PEEK 1000 produced by Novamen Ltd. (Schlieren, Switzerland), PDMS-PTFPMS/PVDF OSN membranes, solvent-stable polymeric nanofiltration membranes (N30F, NF-PES-10, MPF-44 and MPF-50), silicone membranes, hollow fiber ultrafiltration (UF) membrane module, supplied by PAM Membranas Seletivas Ltda., poly(ethersulfone)/poly(vinylpyrrolidone) PES/PVP) membranes, poly(vinylidene fluoride) (PVDF-Si and PVDF-CA) membranes, composite membrane (MPF-50), PDMS-PTFPMS/PVDF composite membranes, can be used.

Membrane Pore Diameter

The membrane pore diameter may be about 50, 75, 100, 125, 150, 175, 200, 225, 250, 275, 300, 325, 350, 375, 400, 425, 450, 475, or 500 Daltons. The membrane pore diameter may between 50 Daltons and 500 Daltons, 100 Daltons and 300 Daltons, 150 Daltons and 250 Daltons, and 100 and 400 Daltons. The membrane pore diameter serves as a molecular weight cutoff value. The membrane pore diameter may be about 50, 75 100, 125, or 150 Daltons. The membrane pore diameter may be about 150 Daltons.

Solvent Temperatures

The temperature of the solvent range from about 20° C. to about 70° C., from about 25° C. to about 50° C., from about 25° C. to about 40° C., from about 30° C. to about 60° C., or from about 29° C. to about 50° C. These temperature ranges can also be expressed as from about 25° C. to about 40° C., from about 30° C. to about 60° C., from about 30° C. to about 50° C., from about 27° C. to about 30° C., from about 40° C. to about 60° C., from about 60° C. to about 68° C., from about 35° C. to about 50° C., from about 40° C. to about 55° C., or from about 41° C. to about 60° C. Thus, the temperature of the solvent can be about 25° C., about 26° C., about 27° C., about 28° C., about 29° C., about 30° C., about 31° C., about 32° C., about 33° C., about 35° C., about 36° C., about 38° C., about 40° C., about 41° C., about 45° C., about 48° C., about 54° C., about 55° C., or about 65° C.

Solvent Pressures

The pressure of the solvent at a membrane may range from about 50 pound-force per square inch (psi) to about 600 psi, about 75 psi to about 500 psi, about 100 psi to about 400 psi, about 125 psi to about 300 psi, or about 150 psi to about 250 psi. Suitable operating pressure ranges can also be expressed as about 50 psi to about 100 psi, from about 100 psi to about 150 psi, from about 150 psi to about 200 psi, from about 200 psi to about 250 psi, from about 250 psi to about 300 psi, from about 300 psi to about 350 psi, from about 350 psi to about 400 psi, from about 400 psi to about 450 psi, or from about 450 psi to about 500 psi.

Volumetric Flow Rate of Solvent

The volumetric flow rate (Q) of the solvent at a membrane depends on the surface are of the membrane. For example, the volumetric flow rate of the solvent can be from about 0 L/h to about 1000 L/h, from about 10 L/h to about 750 L/h, from about 20 L/h to about 500 L/h, from about 30 L/h to about 450 L/h, from about 40 L/h to about 400 L/h, from about 50 L/h to about 350 L/h, from about 75 L/h to about 300 L/h, from about 100 L/h to about 250 L/h. In full scale processes in which the surface area of the membrane is greater than about 25 m2, the volumetric flow rate of the solvent may exceed 1000 L/h. The volumetric flow rate of the solvent may also range from about 0 L/h to about 10 L/h, from about 10 L/h to about 50 L/h, from about 50 L/h to about 100 L/h, from about 100 L/h to about 200 L/h, from about 200 L/h to about 400 L/h, from about 400 L/h to about 600 L/h, from about 600 L/h to about 800 L/h, from about 800 L/h to about 1000 L/h. Solvent volumetric flow rates include about 5 L/h, about 10 L/h, about 15 L/h, about 20 L/h, about 25 L/h, about 50 L/h, about 75 L/h, about 100 L/h, about 125 L/h, about 150 L/h, about 175 L/h, about 200 L/h, about 250 L/h, about 400 L/h, about 600 L/h, about 800 L/h, about 1000 L/h.

Permeate Temperature

The temperature of the permeates range from about 20° C. to about 70° C., from about 25° C. to about 50° C., from about 25° C. to about 40° C., from about 30° C. to about 60° C., or from about 29° C. to about 50° C. These temperature ranges can also be expressed as from about 25° C. to about 40° C., from about 30° C. to about 60° C., from about 30° C. to about 50° C., from about 27° C. to about 30° C., from about 40° C. to about 60° C., from about 60° C. to about 68° C., from about 35° C. to about 50° C., from about 40° C. to about 55° C., or from about 41° C. to about 60° C. Thus, the temperature of the permeate can be about 25° C., about 26° C., about 27° C., about 28° C., about 29° C., about 30° C., about 31° C., about 32° C., about 33° C., about 35° C., about 36° C., about 38° C., about 40° C., about 41° C., about 45° C., about 48° C., about 54° C., about 55° C., or about 65° C.

Pressures

The disclosed methods employ pressures of the permeates include ranges from about 50 pound-force per square inch (psi) to about 500 psi, about 75 psi to about 500 psi, about 100 psi to about 400 psi, about 125 psi to about 300 psi, or about 150 psi to about 250 psi. Other pressure ranges include about 50 psi to about 100 psi, from about 100 psi to about 150 psi, from about 150 psi to about 200 psi, from about 200 psi to about 250 psi, from about 250 psi to about 300 psi, from about 300 psi to about 350 psi, from about 350 psi to about 400 psi, from about 400 psi to about 450 psi, or from about 450 psi to about 500 psi.

Permeate Flow Rate

The flow rate of the permeates can be 0-1,000 liters per hour. Because the flow rate is proportional to the surface area of the membrane, the flow rate of the permeate may scale much higher. In other words, the flux of the permeate through the membrane ranges from about 0 L/h·m² to about 1000 L/h·m², from about 10 L/h·m² to about 750 L/h·m², from about 20 L/h·m² to about 500 L/h·m², from about 30 L/h·m² to about 450 L/h·m², from about 40 L/h·m² to about 400 L/h·m², from about 50 L/h·m² to about 350 L/h·m², from about 75 L/h·m² to about 300 L/h·m², from about 100 L/h·m² to about 250 L/h·m². The flux of the permeate through the membrane may also range from about 0 L/h·m² to about 10 L/h·m², from about 10 L/h·m² to about 50 L/h·m², from about 50 L/h·m² to about 100 L/h·m², from about 100 L/h·m² to about 200 L/h·m², from about 200 L/h·m² to about 400 L/h·m², from about 400 L/h·m² to about 600 L/h·m², from about 600 L/h·m² to about 800 L/h·m², from about 800 L/h·m² to about 1000 L/h·m². Particular fluxes within such ranges include about 5 L/h·m², about 10 L/h·m², about 15 L/h·m², about 20 L/h·m², about 25 L/h·m², about 50 L/h·m², about 75 L/h·m², about 100 L/h·m², about 125 L/h·m², about 150 L/h·m², about 175 L/h·m², about 200 L/h·m², about 250 L/h·m², about 400 L/h·m², about 600 L/h·m², about 800 L/h·m², about 1000 L/h·m².

Retentate Flow Rate

The flow rate of a retentate can be 0.1-100 liters per hour.

Fluxes of the permeate

Fluxes of the permeate through a membrane may range from about 0 L/h·m² to about 1000 L/h·m², from about 10 L/h·m² to about 750 L/h·m², from about 20 L/h·m² to about 500 L/h·m², from about 30 L/h·m² to about 450 L/h·m², from about 40 L/h·m² to about 400 L/h·m², from about 50 L/h·m² to about 350 L/h·m², from about 75 L/h·m² to about 300 L/h·m², from about 100 L/h·m² to about 250 L/h·m². Other suitable fluxes of the permeate through the membrane include ranges from about 0 L/h·m² to about 10 L/h·m², from about 10 L/h·m² to about 50 L/h·m², from about 50 L/h·m² to about 100 L/h·m², from about 100 L/h·m² to about 200 L/h·m², from about 200 L/h·m² to about 400 L/h·m², from about 400 L/h·m² to about 600 L/h·m², from about 600 L/h·m² to about 800 L/h·m², from about 800 L/h·m² to about 1000 L/h·m². Thus, the flux of the permeate through the membrane can be about 5 L/h·m², about 10 L/h·m², about 15 L/h·m², about 20 L/h·m², about 25 L/h·m², about 50 L/h·m², about 75 L/h·m², about 100 L/h·m², about 125 L/h·m², about 150 L/h·m², about 175 L/h·m², about 200 L/h·m², about 250 L/h·m², about 400 L/h·m², about 600 L/h·m², about 800 L/h·m², about 1000 L/h·m². These fluxes correspond to flow rates of 0-600 liters per hour, or higher depending on the scale of the process (e.g., membrane surface area).

The retentate can comprise less than 0.5%, 0.1%, 0.01%, or 0.001% w/w pesticides, fungicides, fertilizers, and mixtures thereof. For example, the retentate can comprise a concentration of pesticides or fungicides ranging from about 0 ppm to 10 ppm.

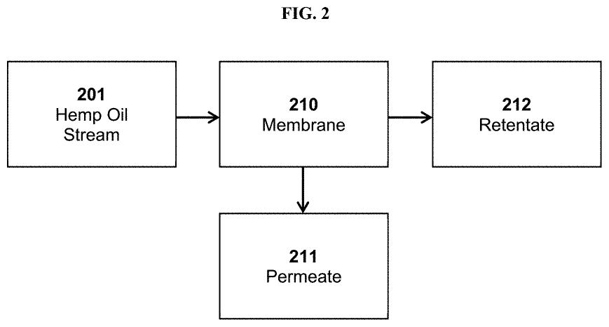

Making reference to FIG. 2, the method includes subjecting crude hemp seed oil stream 201 as described herein to filtration 210. The retentate 212 includes refined hemp seed oil. The permeate 211 comprises the solvent used to prepare liquid 201.

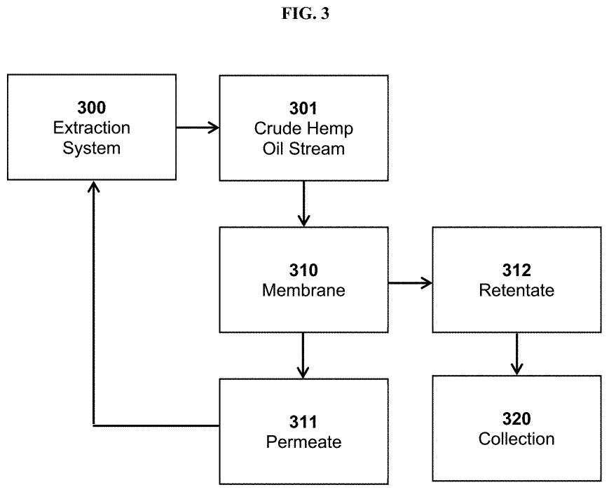

Another method is shown in the flow chart of FIG. 3. Extraction 300 can be performed by mixing shelled or whole Cannabis seeds into the solution with agitation (e.g., mixing) and subjecting it to sonication. The crude hemp seed oil stream 301 is then separated from the Cannabis seed material and allowed to flow through a drain for filtration. Following ultrasonic cavitation treatment, the crude hemp seed oil stream is subjected to a filtration step 310, liquid 301 is passed through a membrane. The retentate 312 includes the hemp seed oil, which may be collected 330. The permeate 311 includes the solvent used to prepare liquid 301, which can be recycled back into extraction 300.

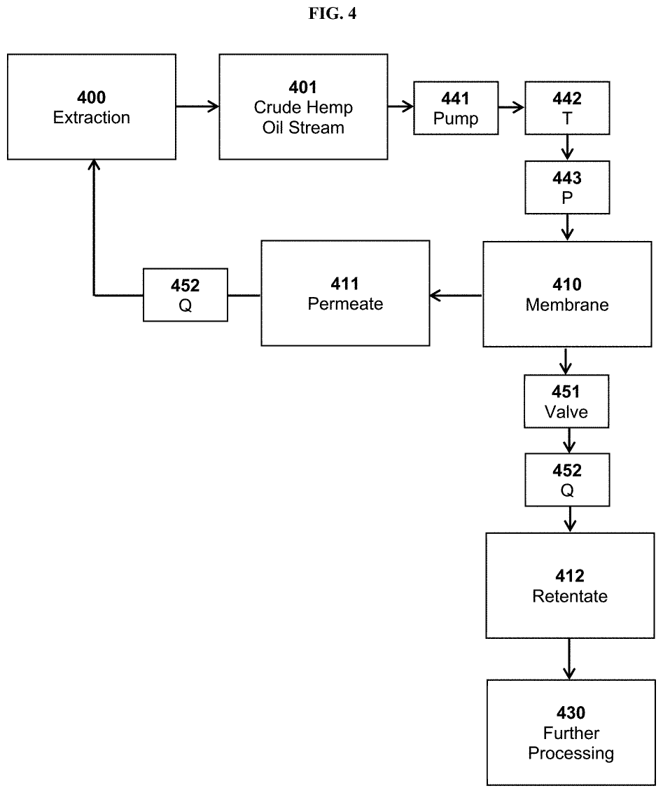

FIG. 4 shows another method of preparing refined hemp seed oil that includes a step of extraction 400, which can be performed using ultrasonic cavitation as described herein. The resulting crude hemp seed oil stream 401 is pumped using pump 441, the temperature of the liquid is measured using temperature gauge 442, and the pressure is measured using pressure gauge 443. Liquid 401 is then subjected to filtration step 410. The retentate 412, including refined hemp seed oil, flows through back pressure valve 451, and flowmeter 452. Flowmeter 452 is used to measure the flow rate (Q) of permeate 411, which includes the recovered solvent and is recycled into extraction 400. The retentate comprising the refined hemp seed oil can be collected for further processing.

Further embodiments of the present invention will now be described with reference to the following examples. The examples contained herein are offered by way of illustration and not by any way of limitation.

### EXAMPLES

The methods described herein will now be described with reference to the following examples. The examples contained herein are offered by way of illustration and not by any way of limitation.

### Example 1

### Hemp Seed Oil Extraction from Henola Hemp Seeds

Hemp seed oil extraction using sonication in hexane was compared to hemp seed oil extraction using a press expeller. 5 or 10 gram samples of Henola hemp (Monoecious, high-yielding grain and oil seed cultivar. Bred by Poland's Institute of Natural Fibers and Medicinal Plants) grown in Michigan and aged about 1-5 days post-harvest were processed. The hemp seed oil was compared on the basis of oil extracted and color. The reported oil content of the hemp seed oil ranged between 34% and 49% oil. Whole hemp seeds and hulled hemp seeds (“hemp hearts”) were tested for hemp seed oil extraction efficiency.

### Sonification Rod (Horn)

5 and 10 gram samples of Henola hemp seeds, both whole seed and hulled hemp seeds were soaked in hexane for 10 minutes and then subjected to ultrasonic cavitation using a sonification horn operating at about 35 kHz at 100 W in a hexane solvent for 0, 60, or 120 seconds. The ratio of solvent to hemp seed was between 3.1:1 and 6.8:1.

TABLE 1
Sonication Experiments with whole and hulled hemp seeds

| | | Ultra- | | | | |
|---|---|---|---|---|---|---|
| | Soak | sound | | Oil in | | Extraction |
| | Time | Time | Seed | Seed | | Efficiency |
| Sample | (min) | (min) | (g) | (%) | Solvent:Seed | (%) |
| 1 | 10 | 1 | 10 | 29.6% | 3.1:1 | 87.1% |
| 2 | 10 | 0 | 10 | 21.7% | 3.2:1 | 63.9% |
| 3 | 10 | 2 | 10 | 28.7% | 3.5:1 | 84.6% |
| 4^{†} | 10 | 1 | 10 | 31.9% | 3.4:1 | 94.1% |
| 5^{†} | 10 | 1 | 5 | 34.0% | 6.8:1 | 100.1% |

^{†}Hemp seeds were hulled, e.g., hemp hearts were tested.

For the expeller trial, a 500 gram sample of whole hemp seeds were crushed in an expeller (NutriChef Countertop Kitchen Oil Press, Model #PKOPR15). 10 and 30 gram samples of the expeller pressed meal was collected and soaked in hexane for 10 or 30 minutes and then subjected to ultrasonic cavitation using a sonification horn operating at about 35 kHz at 100 W in a hexane solvent for 0 or 60 seconds. The ratio of solvent to hemp seed was between 3.1:1 and 6.8:1.

TABLE 2
Expeller Pressed Hemp Seeds

| | Seed Mass | Oil Pressed | Extraction Efficiency |
|---|---|---|---|
| Sample | (g) | (%) | (%) |
| 6 | 500 | 24.1% | 70.8% |

TABLE 3
Sonication Experiments with expeller pressed hemp seed meal

| | | Ultra- | | | | |
|---|---|---|---|---|---|---|
| | Soak | sound | | Oil in | | Extraction |
| | Time | Time | Seed | Meal | | Efficiency |
| Sample | (min) | (min) | (g) | (%) | Solvent:Meal | (%) |
| 7 | 10 | 1 | 10 | 9.52% | 3.4:1 | 98.8% |
| 8 | 30 | 0 | 5 | 7.52% | 6.5:1 | 92.9% |

Both the expeller and hexane soak extracted some hemp seed oil from the hemp seeds, but adding sonication demonstrated improvements to extraction yield and reduction in overall excess plant matter. The hemp seed oil produced by the expeller was dark green in color, a sign of contamination by plant material. In contrast, the hemp seed oil was yellow in color, a sign that the sample was free of extraneous plant material. Hulling the hemp seeds also improved hemp seed oil extraction.

The ultrasonic treatment surprisingly leads to about a 36% increase in hemp seed oil extraction, as compared to no ultrasonic treatment. It has been surprisingly discovered that the solvent and ultrasonic conditions used were successful in extracting 100% of the hemp seed oil from the seeds but without disrupting the cannabis plant matter. It was unexpected when a relatively low ultrasonic setting at a short time period lead to nearly complete release of the hemp seed oil from the hemp seeds but without extracting other the plant materials. The advantage of this process is that it does not release organelles, nucleic acids, fibers, or lignin which tend to foul membranes in the downstream extraction steps. This greatly reduces the amount of biomass processed after the step, saving time and costs for hemp seed oil extraction from hemp seeds.

### Definitions

Unless defined otherwise, all technical and scientific terms used herein have the same meaning as those commonly understood by one of ordinary skill in the art.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described herein, the steps can be carried out in any order without departing from the principles of this disclosure, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

“Cannabis seed material,” “cannabis,” and “cannabis material,” as used herein, refers broadly to any cannabis seed or part thereof, this includes whole hemp seeds and hulled (de-shelled) hemp seeds, also known as “hemp hearts”. Cannabis plant material also refers broadly to hemp that includes but is not limited to cannabis plants with less than 0.3% THC content by weight. Hemp and industrial hemp can be used interchangeably as both refer to cannabis plants with less than 0.3% THC content by weight.

“Cannabis,” as used herein, refers broadly to all plants of the genus cannabis and/or the family cannabaceae, including but not limited to all plants of the species Cannabis sativa, Cannabis indica, and Cannabis ruderalis. Hybrids, strains, clones, cultivars, and varieties are also included. Cannabis also broadly includes hemp.

“Crude hemp seed oil stream” as used herein, refers broadly to a solvent comprising mixture of solvent and hemp seed oil.

“Crude hemp seed oil,” also referred to as, “full spectrum hemp seed oil,” as used herein, refers to a liquid mixture produced from hemp seeds comprises fatty acids, proteins, carbohydrates, plant material, chlorophyll, and mixtures thereof. Full spectrum hemp seed oil is generally dark green to dark brown in color.

“Refined hemp seed oil,” or “refined hemp seed oil, as used herein, refers broadly to an oil derived from hemp seeds consisting essentially of the fatty acids (e.g., linoleic acid, α-linolenic acid, oleic acid, palmitic acid, stearic acid, γ-linolenic acid, eicosanoic acid) from the hemp seed. Refined hemp seed oil is generally light yellow in color, partially translucent.

“Molecular weight cutoff,” as used herein, refers broadly to the minimum molecular weight of a solute that is 90% retained by a membrane. See, e.g., Kim et al. Journal of Membrane Science 87: 35-46 (1994) using dextran and a transmembrane pressure of 50 kPa.

“Ultrasonics” or “ultrasonic waves,” as used herein, refers broadly to sound waves (mechanical waves) with high frequency about between 15 kHz to 40 kHz (e.g., about 20 kHz) and low amplitude of about between 0.0001-0.025 mm.

Although the subject matter disclosed herein has been described in some detail by way of illustration and example for purposes of clarity of understanding, it should be understood that certain changes and modifications can be practiced within the scope of the appended claims. Modifications of the above-described methods would be understood in view of the foregoing disclosure or made apparent with routine practice or implementation of the described methods to persons of skill in extraction chemistry; extraction processing, mechanical engineering, and/or related fields are intended to be within the scope of the following claims.

All publications (e.g., non-patent literature), patents, patent application publications, and patent applications mentioned in this specification are indicative of the level of skill of those skilled in the art to which this disclosure pertains. All such publications (e.g., non-patent literature), patents, patent application publications, and patent applications are herein incorporated by reference to the same extent as if each individual publication, patent, patent application publication, or patent application was specifically and individually indicated to be incorporated by reference.

While the foregoing methods have been described in connection with this disclosure, it is not to be limited thereby but is to be limited solely by the scope of the claims which follow.

1-86. (canceled)

87. A method for extracting Cannabis seed oil comprising:
applying ultrasonic cavitation with an ultrasonic cavitation device to a mixture comprising Cannabis seed material and at least one solvent in an extraction tank, to produce a crude hemp seed oil stream;
the extraction tank having a first end proximal to the ultrasonic cavitation device and a second end distal to the ultrasonic cavitation device;
the extraction tank comprising a screw conveyor located inside the extraction tank, the screw conveyor capable of moving the Cannabis seed material from the first end to the second end;
wherein the extraction tank has a drain configured to collect the crude hemp seed oil stream; and
filtering the crude hemp seed oil stream through at least one membrane to produce a refined hemp seed oil, and
further comprising moving the Cannabis seed material to an output port located at the second end.

88. The method of claim 87, further comprising moving the Cannabis seed material to an output port located at the second end.

89. The method of claim 87, wherein the screw conveyor is a varied geometry screw conveyor.

90. The method of claim 87, wherein the screw conveyor has a central axis, the central axis making an incline angle θ of about 1° to about 45° C. relative to a horizontal plane intersecting the central axis.

91. The method of claim 87, wherein the sonication device produces an ultrasound frequency between 10 kHz to 100 kHz.

92. The method of claim 87, wherein the ultrasonic cavitation is applied at a power of 500 to 1,000 kW/kg of Cannabis seed material and at least one solvent by weight.

93. The method of claim 87, wherein the cannabis seed material is ejected at the opposite terminus from the input into the screw conveyor, optionally by means of screw conveyor.

94. The method of claim 87, wherein the mixture comprising Cannabis seed material and at least one solvent has a temperature between 25° C. and 68° C.

95. The method of claim 87, wherein the solvent is an organic solvent, water, or a combination thereof.

96. The method of claim 94, wherein the organic solvent is hexane.

97. The method of claim 87, wherein the ultrasonic cavitation is applied for between 30 seconds and 5 minutes.

98. The method of claim 87, wherein the ultrasonic cavitation is applied in pulses.

99. The method of claim 87, wherein the membrane filtration comprises a membrane filter producing a retentate and a permeate.

100. The method of claim 87, wherein the membrane has a molecular weight cutoff of about 150 Daltons.

101. The method of claim 87, wherein the retentate comprises refined hemp seed oil.

102. The method of claim 101, wherein the retentate is substantially free of terpenes, pesticides, fungicides, cannabinoids, solvents, plant material, organelles, nucleic acids, lignin, hemicellulose, cellulose, fertilizers, and mixtures thereof.

103. The method of claim 87, wherein the membrane is an organic solvent stable membrane.

104. A system for extracting Cannabis seed oil comprising:
an extraction tank having a first end proximal to an ultrasonic cavitation device and a second end distal to the ultrasonic cavitation device;
the extraction tank comprising a screw conveyor located inside the extraction tank, the screw conveyor capable of moving material from the first end to the second end,
wherein the extraction tank has a drain configured to collect a crude hemp seed oil stream,
wherein the screw conveyor is food-grade material; and
in fluid communication with at least one membrane filtration system, wherein the membrane is an organic solvent stable membrane and the membrane has a molecular weight cutoff of about 150 Daltons.

105. The system of claim 104, wherein the screw conveyor is a varied geometry screw conveyor.

106. The system of claim 104, wherein the screw conveyor has a central axis, the central axis making an incline angle θ of about 1° to about 45° C. relative to a horizontal plane intersecting the central axis.
